(19) United States
(12) Patent Application Publication
(10) Pub. No.: US 2026/0314627 A1
(43) Pub. Date: Oct. 15, 2026

(54) CONVEYING SYSTEM FOR CASTING MOLDS FOR THE PRODUCTION OF FOOD PRODUCTS

(71) Applicant: Bühler GmbH, Reichshof (DE)

(72) Inventors: Marc WUTTE, Köln (DE); Marko SCHEPERS, Overath (DE); Alexander ANOKHIN, Köln (DE)

(21) Appl. No.: 19/643,402

(22) Filed: Apr. 9, 2026

(30) Foreign Application Priority Data
Apr. 9, 2025 (EP) 25169544.1

(51) Int. Cl. A23G 3/02; A23G 3/34

(52) U.S. Cl. CPC A23G 3/0278; A23G 3/0027; A23G 3/0268

(57) ABSTRACT

A conveying system for casting molds for the production of food products, in particular confectionery, which includes a conveying unit, at least one casting mold, and a weighing unit, wherein the conveying unit is configured to transport the casting mold in a predefined conveying direction at a predetermined speed when the force-locking and/or interlocking connection is established, wherein the weighing unit is arranged in the conveying direction, wherein the weighing unit is configured to transport the casting mold for a predetermined distance in the conveying direction at a second speed, wherein the conveying unit is configured to substantially break a force-locking and/or interlocking connection at least for the predetermined distance, and wherein the weighing unit is configured to establish the weight of the casting mold within the predetermined distance.

### CROSS-REFERENCE TO RELATED APPLICATION

This application claims priority pursuant to 35 U.S.C. 119(a) to European Patent Application No. 25169544.1, filed Apr. 9, 2025, which application is incorporated herein by reference in its entirety.

### TECHNICAL FIELD

The invention relates to a conveying system for casting molds for the production of food products, to a method for operating a conveying system to produce food products, and to a control unit for operating a conveying system.

### BACKGROUND

Currently, several different solutions exist for transporting casting molds or similar items in the food industry. Increasing demands placed on the sustainability of food production as well as greater requirements placed on quality by the customer ensure a continuous need for innovative and robust solutions for conveying systems in the food sector.

### SUMMARY

The aim of the present invention is to provide an improved conveying system for casting molds to produce food products, which has the features of independent Claim 1.

One advantage of the present invention can be considered to be the fact that during operation, preferably continuous or in-line operation, of the conveying system, the weight of each mold can be established without interruption, and thus the mass with which the casting mold is filled can be continuously optimized in order to achieve the target weight of the casting mold filling as accurately as possible. Another advantage is that deviations in weight can allow inconsistencies within the process chain to be detected early, to trigger maintenance steps or the like, for example. Another advantage can be that the weight of the food product with which the casting mold is filled can be established individually for each casting mold without pausing the conveying system or the manufacturing process. Thus, the weight of the casting mold or the food product with which it is filled can be established without the use of personnel. Another advantage, for example, may be that if the amount of food product dispensed into the casting mold is underweight and/or overweight, a quick response is possible if a deviation is detected, in particular significantly faster than in existing systems where the weight is only established after the food product has been removed from the casting mold. Thus, the faster adjustment capability via in-line weight determination can in particular prevent a large amount of food product waste.

This is achieved according to the invention by the fact that the conveying system for casting molds for the production of food products, in particular confectionery, comprises:
a conveying unit;
at least one casting mold; and,
a weighing unit, wherein the conveying unit is configured to establish a force-locking and/or interlocking connection with at least one casting mold, wherein the conveying unit is configured to transport the casting molds in a predefined conveying direction at a predetermined speed when the force-locking and/or interlocking connection is established, wherein the weighing unit is arranged in the conveying direction, wherein the weighing unit is configured to transport the casting mold for a predetermined distance in the conveying direction at a second speed, wherein the conveying unit is configured to substantially break the force-locking and/or interlocking connection at least for the predetermined distance, and wherein the weighing unit is configured to establish the weight of the casting mold within the predetermined distance.

In other words, the conveying unit places the casting mold onto the weighing unit by releasing the force-locking and/or interlocking connection, wherein the weighing unit transports the casting mold at such a speed that the casting mold is devoid of contact with the conveying unit in order to establish the weight of the casting mold. Within this context, “to substantially break” can mean in particular that there is no contact whatsoever between the casting mold and the conveying unit that influences the process of weighing the casting mold to establish its weight. Further preferably, in this context, “substantially break” can mean that the conveying unit places the casting mold onto the weighing unit and only by the casting mold being driven by the weighing unit is the casting mold spaced apart from the conveying unit. As soon as the weighing unit engages with the casting mold and transports it at the second speed, the casting mold is spaced apart from the conveying unit or the engagement element of the conveying unit that engages with the casting mold such that the force-locking and/or interlocking connection is broken. As soon as there is no contact between the casting mold and the conveying unit, the weight of the casting mold can be correctly determined by the weighing unit, especially without indifferences or the conveying unit influencing the casting mold and/or the weighing unit. For example, in a continuously running conveying unit with chains and chain studs that can engage with the casting mold, the mold can be decoupled from the chain studs and other system components during the weighing process by means of the conveying system. This preferably allows for reliable results to be established when measuring the weight of the casting mold or the food product with which the casting mold is filled during continuous operation of the conveying system, especially at full or maximum system speed. This can be achieved by the conveying unit temporarily placing the casting mold on the weighing unit, and the weighing unit continuing to transport the casting mold all the while it is placed thereon.

The dependent claims present preferred developments of the invention.

Preferably, the second speed is equal to or greater than the predetermined speed such that the weight of the casting mold is established without contact with the conveying unit.

One advantage of this embodiment is that by targetedly controlling the second speed, the casting mold can be spaced apart from the conveying unit in order to thus minimize or avoid measurement errors caused by contact between the casting mold and the conveying unit. Preferably, the second speed can in particular be selected in such a way that the casting mold is spaced apart from the conveying unit, thus making weighing easier.

Further preferably, the conveying unit has at least a first belt unit and a second belt unit, on each of which at least one engagement element is arranged, which is configured to engage with the casting mold in order to establish the force-locking and/or interlocking connection, wherein the first belt unit is substantially opposite and parallel to the second belt unit, wherein the conveying unit has a first guide element and a second guide element, which are configured to guide the first belt unit and the second belt unit, and wherein the first guide element and the second guide element are configured to increase the distance along a first axis between the engagement elements opposite one another. A belt unit can also be a circulating chain or the like.

One advantage of this embodiment is that by increasing the distance between the engagement elements, the force-locking and/or interlocking connection between the casting mold and the conveying unit can be broken. This can ensure that the weighing process is not affected. Preferably, the first and second guide elements can be a guide or similar for the first belt unit and the second belt unit, respectively. Since the casting molds can be connected to the first and second belt units, the casting molds follow the path defined by the guide elements in the conveying direction. This path aligns the casting molds with respect to the weighing unit in such a way that the force-locking and/or interlocking connection between the conveying unit and the casting mold can be broken or restored for the predetermined distance. “Substantially parallel” can, in this context, in particular mean a deviation of +/−10°.

Further preferably, the first guide element and the second guide element are configured to increase the distance between the engagement elements up to a predetermined limit value in order to break the force-locking and/or interlocking connection for the predetermined distance.

One advantage of this embodiment is that the predetermined limit value can be chosen in such a way as to ensure safe transfer of the casting mold from the conveying unit to the weighing unit.

More preferably, the first guide element and the second guide element are configured to reduce the distance between the engagement elements after leaving the predetermined distance to restore the force-locking and/or interlocking connection.

One advantage of this embodiment is that, as soon as the process step of weighing the casting mold is completed, the engagement elements engage with the casting mold and restore the force-locking and/or interlocking connection, thus creating space on the weighing unit for the next casting mold. This allows for uninterrupted determination of the weights of each casting mold placed onto the weighing unit.

More preferably, the conveying unit is configured to place the casting mold onto the weighing unit within the predetermined distance to break the force-locking and/or interlocking connection.

One advantage of this embodiment is that by creating a distance between the casting mold and the conveying unit, the process of measuring the weight of the casting mold is not affected.

More preferably, the conveying unit is designed to pick the casting mold back up from the weighing unit past the predetermined distance.

One advantage of this embodiment is that the weight can be established without interrupting the conveying system, since the conveying unit picks the casting mold back up and thus creates space for the next casting mold.

Preferably, the first guide element and the second guide element are configured to displace the engagement elements along a second axis, which is substantially orthogonal to the first axis, to transfer the casting mold to the weighing unit and/or pick it up from the weighing unit.

One advantage of this embodiment is that a layer of security is added, since by pulling out and lowering the engagement elements, it is possible to ensure that the weight established is not influenced by the conveying unit, and also that if the casting mold should fall off the weighing unit, it will fall back onto the engagement elements, thus preventing the conveying unit from becoming blocked or the like. In this context, “substantially orthogonal” in particular includes a deviation of +/−10°. Preferably, the term “to pick up” can be understood to mean any type of process or the like which restores the force-locking and/or interlocking connection between the conveying unit and the casting mold after the casting mold has been weighed.

More preferably, the first guide element and the second guide element are configured to break and/or establish the force-locking and/or interlocking connection by means of a two-dimensional movement along the first axis and the second axis.

One advantage of this embodiment is that the two-dimensional movement can be adapted to the relevant conditions for each application scenario of the conveying system or to each casting mold.

Further preferably, a projection is arranged on each of the first guide element and the second guide element, wherein the projection is designed to guide the at least one casting mold in the conveying direction.

One advantage of this embodiment is that a tilting movement or the like of the casting mold can be prevented, since it rests on or slides over the projection.

More preferably, the conveying unit has at least one support projection which is arranged between the first belt unit and the second belt unit, wherein the support projection is arranged at a predetermined distance from the weighing unit to make it easier to slide the casting mold onto the weighing unit.

One advantage of this embodiment is that casting molds can sag slightly, with the support projection helping to ensure uninterrupted loading onto the weighing unit.

Preferably, the conveying system is configured such that, for the predetermined distance, the casting mold is substantially only in contact with the weighing unit.

One advantage of this embodiment is that the establishment of the weight of the casting mold is not distorted by other components.

Preferably, the weighing unit has at least one moving element which is configured to transport the casting mold for the predetermined distance at the second speed.

One advantage of this embodiment is that the moving element is arranged directly on the weighing unit, thus ensuring that the measurement result when establishing the weight of the casting unit is not distorted. More preferably, the moving element can be, for example, a conveyor belt or the like, to be able to transport the casting mold at the second speed.

Further preferably, the conveying system has at least one sensor element, wherein the weighing unit is configured to establish the position of the casting mold by means of the sensor element, wherein the weighing unit is configured to establish the weight of the casting mold when the position of the casting mold is within the predetermined distance.

One advantage of this embodiment is that the sensor element can further increase the quality with which the weight of the casting mold is measured, since the weight values are queried when the casting mold is in the position provided for this purpose. This can ensure that any deviations in weight due to incorrect or inaccurate positioning can be disregarded.

Further preferably, the weighing unit comprises a lifting mechanism, wherein the lifting mechanism is configured to create a distance between the weighing unit and the conveying direction in such a way that, for a predetermined period of time, the weighing unit is devoid of contact with a casting mold in order to tare the weighing unit.

One advantage of this embodiment is that the weighing unit can be tared without interrupting the conveying system, thus further increasing the accuracy of measuring the weights of the casting molds. More preferably, the weighing unit may also comprise a calibration step, which may preferably be designed as a maintenance step. More preferably, taring can take place during operation of the conveying system such that this represents a process step which, however, does not interrupt the transportation of the casting molds.

More preferably, the casting mold has a shoulder on each of its opposite sides, wherein the engagement elements of the first belt unit and the second belt unit are in engagement with the shoulders for the predetermined period of time in order to transport the casting mold in the conveying direction.

One advantage of this embodiment is that, if the weighing unit is spaced apart from the conveying direction in order to tare the weighing unit, the engagement elements can engage with the shoulders of the casting molds so that the casting molds do not fall out of the conveying system.

More preferably, the conveying system has a plurality of casting molds, wherein the conveying unit is configured to bring only one casting mold of the plurality of casting molds into contact with the weighing unit for the predetermined distance.

One advantage of this design is that a plurality of casting molds can be weighed continuously, thus further increasing overall process reliability.

Further preferably, the first belt unit and the second belt unit are configured to transport the at least one casting mold in the conveying direction at the predetermined speed.

One advantage of this embodiment is that the belt unit can transport the casting mold at different speeds depending on the type of casting mold.

More preferably, the engagement elements are designed to engage with a particular portion of the casting mold in order to form the force-locking and/or interlocking connection between the conveying unit and the casting mold.

One advantage of this embodiment is that the casting mold can be secured with respect to the conveying unit in a variety of dimensions. For example, the engagement element can be a bolt or the like, wherein the casting mold comprises a bushing or the like in the particular portion so that the bolt can engage with the bushing.

Further preferably, the conveying unit is configured to displace the engagement elements out of the particular portion in order to break the force-locking and/or interlocking connection for the predetermined distance.

One advantage of this embodiment is that, for example, by simply inserting or removing a bolt in the form of an engagement element into or from a particular portion in the form of a bushing, the force-locking and/or interlocking connection can be broken using cost-effective elements. More preferably, the shoulders of the casting molds can be attached adjacently to the particular portion such that the bolts of the engagement elements are arranged at a predetermined distance from the shoulders when the casting molds rest on the weighing unit, and when the weighing unit is in a tare position, the bolts can engage with each of the shoulders.

Another aspect of the invention relates to a method for operating a conveying system for the production of food products, in particular confectionery, comprising the steps of:
positioning a casting mold on a weighing unit at a predetermined travel speed of the casting mold; and,
determining the weight of the casting mold by means of the weighing unit at at least the predetermined travel speed, wherein the casting mold is substantially devoid of contact with a conveying unit of the conveying system when determining the weight of the casting mold.

One advantage of this embodiment is that the weight of the casting mold can be established without being influenced by the conveying unit during continuous operation of the conveying system.

Further preferably, the method further comprises the following step:
emitting a deviation signal when the established weight of the casting mold deviates from a target weight of the casting mold by a predetermined amount.

One advantage of this embodiment is that, immediately after determining the weight of the casting mold, a comprehensive system can be notified of the presence of a weight deviation. This in particular allows for a quick response and prevents the further production of or a build-up of defective product.

Further preferably, the method further comprises the following step:
determining an adjustment signal on the basis of the deviation signal, wherein the adjustment signal at least comprises the established weight of the casting mold, a delta between the established weight and the target weight, and/or a correction signal, wherein the correction signal at least comprises an indicator to adjust a further weight of a further casting mold to the target weight.

One advantage of this embodiment is that a plurality of measures can be taken on the basis of the established weight. For example, a delta can be output between the target weight and the established weight. More preferably, a correction signal can be output, to which the quantity of food product with which the other casting molds are filled is adjusted in order to bring the established weight of the other casting molds closer to the target weight for the relevant casting mold. This allows for continuous monitoring and adjustment of the process of filling the casting molds with food product without the need for personnel or further measurement steps.

A further aspect of the invention relates to a control unit for operating a conveying system, which is configured to perform steps of the method described above and below and/or is configured to be connected to a conveying system as described above and below for transmitting signals, and/or is configured to receive a first speed signal and a second speed signal, wherein the first speed signal is indicative of a transport speed of a casting mold when it is in contact with a conveying unit, wherein the second speed signal is indicative of a conveying speed of a weighing unit when the casting mold is in contact with the weighing unit and is substantially devoid of contact with the conveying unit, wherein the control unit is configured to output a delta signal, wherein the delta signal is configured to adjust the first speed signal and/or the second speed signal in order to break the contact between the casting mold and the conveying unit and/or to maintain the contact-free state.

One advantage of this embodiment is that the distance between an engagement element of the conveying unit and a particular portion for engaging the casting mold can be set by means of the control unit by adjusting the first and second speed signals.

Further preferably, the control unit is configured to receive a weight signal, wherein the weight signal is indicative of the mass of a food product with which the casting mold has been filled, wherein the control unit is configured to send an adjustment signal on the basis of the weight signal and a reference for the weight of the casting mold, wherein the adjustment signal is configured to bring the weight signal closer to the reference.

One advantage of this embodiment is that the mass of food product can be adjusted depending on the results of measuring the weight of the casting mold, in order to move toward an optimum or target value.

### BRIEF DESCRIPTION OF THE DRAWINGS

Preferred embodiments of the invention are explained below with reference to the accompanying drawings. In the drawings:

FIGS. 1 to 9 show a conveying system according to one embodiment;

FIGS. 10 and 11 show a flowchart illustrating steps of the method according to one embodiment; and,

FIG. 12 shows a control unit according to one embodiment.

### DETAILED DESCRIPTION OF THE INVENTION

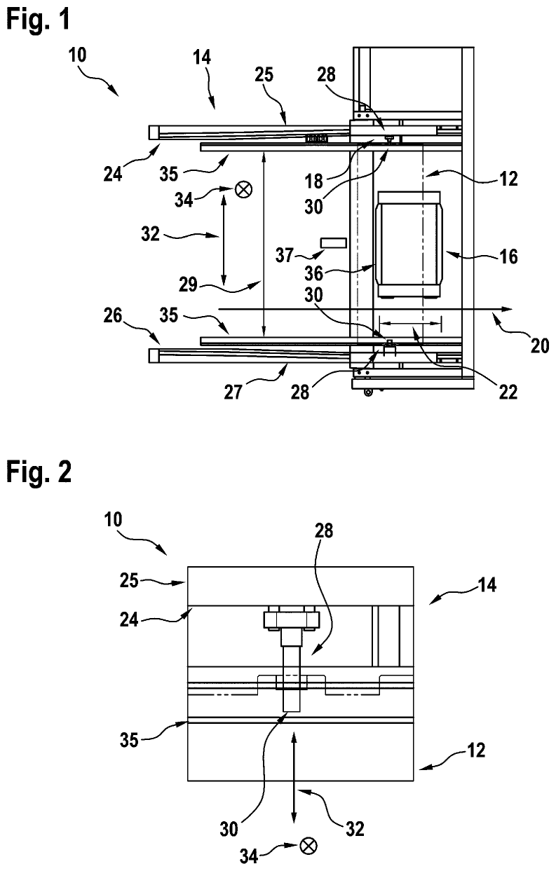

FIG. 1 shows a conveying system 10 according to one embodiment. The system 10 for conveying casting molds 12 to produce food products, especially confectionery, has a conveying unit 14, at least one casting mold 12 and a weighing unit 16. Furthermore, the conveying unit 14 is configured to form a force-locking and/or interlocking connection 18 with at least one casting mold 12, wherein the conveying unit 14 is configured to transport the casting mold 12 in a predefined conveying direction 20 at a predetermined speed when the force-locking and/or interlocking connection 18 is established, wherein the weighing unit 16 is arranged in the conveying direction 20, wherein the weighing unit 16 is configured to transport the casting mold 12 for a predetermined distance 22 in the conveying direction 20 at a second speed, wherein the conveying unit 14 is configured to substantially break the force-locking and/or interlocking connection 18 at least for the predetermined distance 22, and wherein the weighing unit 16 is configured to establish the weight of the casting mold 12 within the predetermined distance 22.

As can be seen in FIG. 1, the conveying system is shown in a plan view. The conveying unit 14 comprises a first belt unit 24 and a second belt unit 26, which are substantially opposite and parallel to one another. More preferably, each belt unit 24, 26 has an engagement element 28 for connection to a casting mold 12. More preferably, the conveying unit 14 has a first guide element 25, which is assigned to the first belt unit 24, and a second guide element 27, which is assigned to the second belt unit 26. Preferably, the first guide element 25 and the second guide element 27 are configured to increase the distance 29 along a first axis 32 between the engagement elements 28 opposite one another. It is further preferred that a projection 35 is arranged on each of the first guide element 25 and the second guide element 27, which is designed to guide the casting mold 12 in the conveying direction 20. More preferably, the first guide element 25 and the second guide element 27 are configured to displace the engagement elements 28 along a second axis 34, which is substantially orthogonal to the first axis 32, in order to place the casting mold onto the weighing unit 16 and/or pick it up from the weighing unit 16. More preferably, the conveying unit 14 has a support projection 37 which is arranged at a predetermined distance from the weighing unit 16 to make it easier to slide the casting mold 12 onto the weighing unit 16.

FIG. 2 shows a conveying system 10 according to one embodiment. The conveying system 10 has a conveying unit 14, which has a first belt unit 24 and a first guide element 25. Preferably, an engagement element 28 is arranged on the first belt unit 24, which can engage with a casting mold 12 in order to establish a force-locking and/or interlocking connection with the casting mold 12. More preferably, the first guide element 25 is configured to displace the engagement element 28 out of the casting mold 12 along a first axis 32 for the predetermined distance 22. More preferably, the first guide element 25 is configured to displace the engagement element 28 along a second axis 34, which is substantially orthogonal to the first axis, when the engagement element 28 is located outside the casting mold.

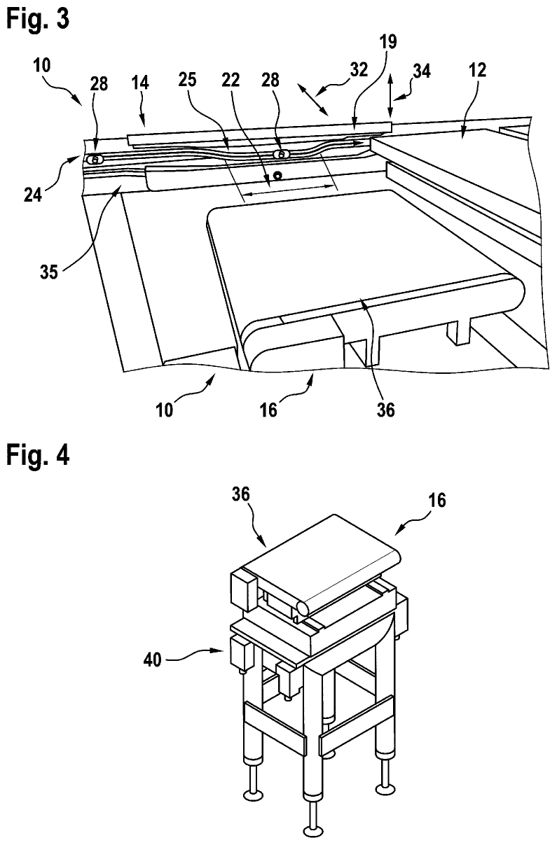

FIG. 3 shows a conveying system 10 according to one embodiment. As can be seen in FIG. 3, the weighing unit 16 is arranged below the first guide element 25 and guides the first belt unit 24 comprising the engagement element 28. Preferably, the first guide element 25 can be designed such that it moves the engagement element 28 both outward along a first axis 32 and downward along a second axis 34. Thus, the casting mold 12 can be lowered onto the weighing unit 16. Preferably, the weighing unit 16 comprises a moving element 36, which is, for example, a conveyor belt in FIG. 3.

FIG. 4 shows a subregion of the conveying system 10 according to one embodiment. The conveying system 10 can, for example, comprise a weighing unit 16 and a sensor element 38. Preferably, the weighing unit 16 comprises a moving element 36 to transport the casting mold 12 at the second speed. More preferably, the weighing unit 16 has a lifting mechanism 40 to lower the weighing unit 16 in relation to the casting mold 12, at least temporarily, to tare the weighing unit 16.

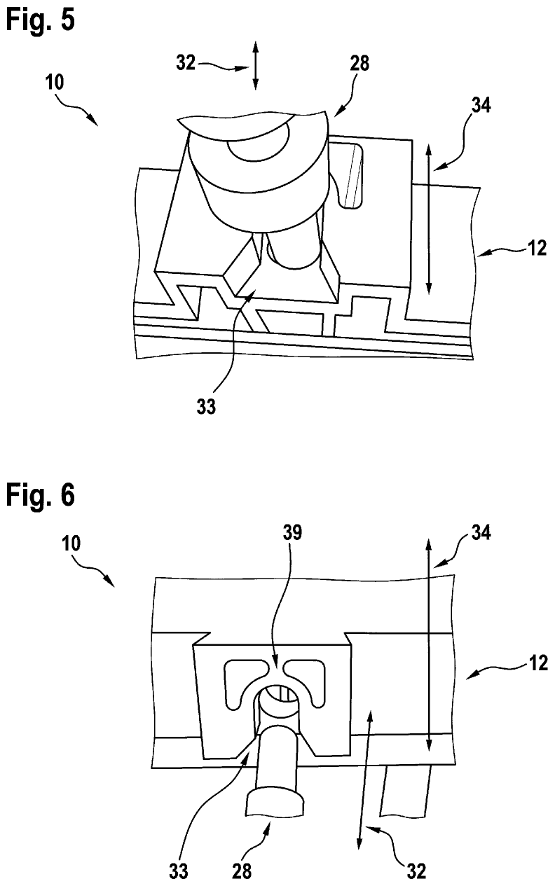

FIG. 5 shows a conveying system 10 according to one embodiment. FIG. 5 illustrates how the engagement element 28 can engage with the casting mold 12. Preferably, the casting mold 12 has a particular portion 30, which may be shaped, for example, as an arc or curve 39 or the like. Preferably, the engagement element 28 can be designed as a bolt, as shown in FIG. 5. Preferably, the bolt of the engagement element 28 engages via a shoulder 33 in the portion 30 of the casting mold 12 to form the force-locking and/or interlocking connection 18, as shown in FIG. 5.

FIG. 6 shows a conveying system 10 according to one embodiment. As shown in FIG. 6, the engagement element 28 was moved out of the particular portion 30 by means of the first guide element 25 and is arranged at a predetermined distance from a shoulder 33. In this position of the engagement element 28 relative to the shoulder 33, if the weighing unit 16 is in a taring position, it is possible to prevent the casting mold 12 being separated from the engagement element 28 and instead the engagement element 28 engages with the shoulder 33.

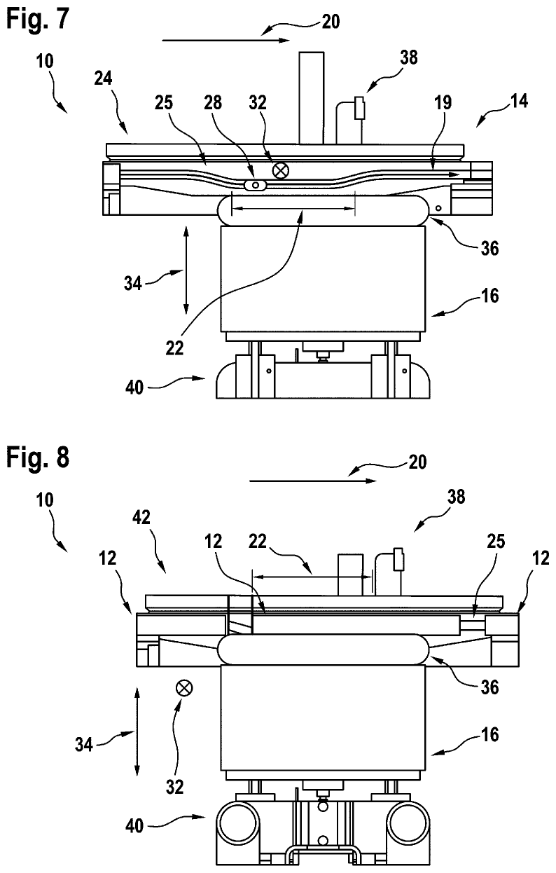

FIG. 7 shows a conveying system 10 according to one embodiment. The conveying system 10 comprises a conveying unit 14. The conveying unit 14 has a first guide element 25 which guides a first belt unit 24 along a predetermined path 19 such that the engagement element 28 can be moved into and out of the casting mold 12. Preferably, the first belt unit 24 is configured to guide the engagement element 28 in the conveying direction 20 such that, within the predetermined distance 22, the force-locking and/or interlocking connection between the casting mold 12 and the engagement element 28 can be broken so that the weighing unit 16 can establish the weight of the casting mold 12 and also transport the casting mold 12 at the second speed by means of the moving element 36. Preferably, a sensor element 38, if it is possible to arrange this on the conveying system 10, can determine the position of the casting mold 12 so that the weight is established, in particular within the predetermined distance 22. More preferably, the first guide element 25 can be designed such that it displaces the engagement element 28 along both a first axis 32 and a second axis 34 in order to break the force-locking connection. Furthermore, the weighing unit 16 comprises a lifting mechanism 40 to create a distance between the moving element 36 or the weighing unit 16 and the casting molds 12 for a predetermined period of time.

FIG. 8 shows a conveying system 10 according to one embodiment. As shown in FIG. 8, the conveying system 10 transports a plurality of casting molds 42, wherein only a single casting mold 12 is in contact with the weighing unit 16 such that the weight of the casting mold 12 can be established. Preferably, the position of the casting mold 12 can be established by means of the sensor element 38 such that the weight of the casting mold 12 can be established as accurately as possible.

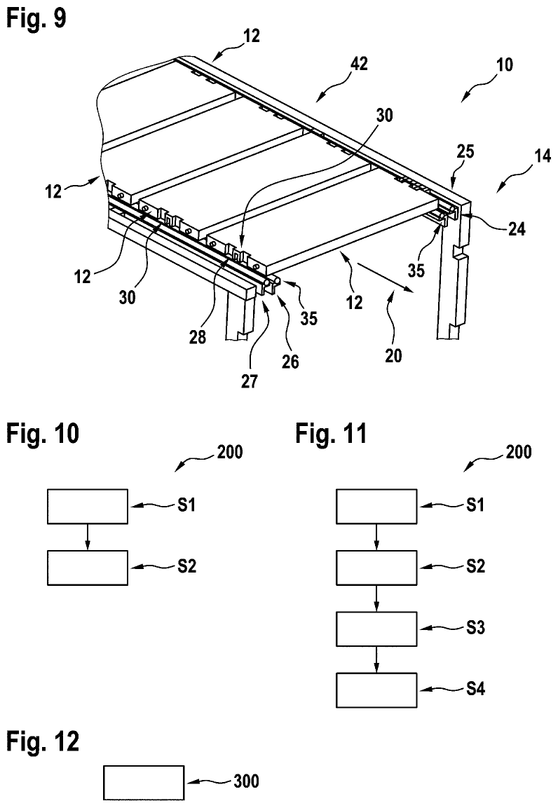

FIG. 9 shows the conveying system 10 according to one embodiment. The conveying system 10 comprises a conveying unit 14. Preferably, the conveying system 10 has a first guide element 25 for guiding the first belt unit 24. More preferably, the conveying unit 14 has a second guide element 27 for guiding the second belt unit 26. As can be seen in FIG. 9, the first belt unit 24 and the second belt unit 26 each have engagement elements 28, which are opposite one another and are provided for each casting mold 12 of the plurality of casting molds 42 on the belt unit 24, 26.

FIG. 10 shows a flowchart to illustrate steps of the method 200 for operating a conveying system 10 for the production of food products, in particular confectionery, according to one embodiment. The method 200 preferably comprises the steps of:
positioning S1 a casting mold 12 on a weighing unit 16 at a predetermined travel speed of the casting mold 12,
determining S2 the weight of the casting mold 12 by means of the weighing unit 16 at at least the predetermined travel speed, wherein the casting mold 12 is substantially devoid of contact with a conveying unit 14 of the conveying system 10 when determining the weight of the casting mold 12.

FIG. 11 shows a flowchart to illustrate steps of the method 200 according to one embodiment. The method 200 preferably has the same steps S1 and S2 as already explained with regard to FIG. 10. Furthermore, the method 200 preferably comprises the step of sending S3 a deviation signal if the established weight of the casting mold 12 deviates from a target weight of the casting mold 12 by a predetermined amount. More preferably, the method 200 comprises the step of establishing S4 an adjustment signal on the basis of the deviation signal, wherein the adjustment signal at least comprises the established weight of the casting mold 12, a delta between the established weight and the target weight and/or a correction signal, wherein the correction signal at least comprises an indicator to adjust a further weight of a further casting mold to the target weight. This can be achieved by providing feedback to a casting machine involved in the process of introducing the mass into the casting molds, by which feedback it is instructed to accordingly change the mass to be introduced into the casting molds in order to achieve the target filling value.

FIG. 12 shows an embodiment of the control unit 300. The control unit 300 is configured to receive a weight signal, wherein the weight signal is indicative of a mass of a food product with which the casting mold 12 has been filled, wherein the control unit 300 is configured to send an adjustment signal on the basis of the weight signal and a reference for the weight of the casting mold 12, wherein the adjustment signal is configured to bring the weight signal closer to the reference.

What is claimed is:

1. A conveying system for casting molds for the production of food products, in particular confectionery, comprising:
a conveying unit;
at least one casting mold; and,
a weighing unit, wherein the conveying unit is configured to form a force-locking and/or interlocking connection with at least one casting mold, wherein the conveying unit is configured to transport the casting mold in a predefined conveying direction at a predetermined speed when the force-locking and/or interlocking connection is established, wherein the weighing unit is arranged in the conveying direction, wherein the weighing unit is configured to transport the casting mold for a predetermined distance in the conveying direction at a second speed, wherein the conveying unit is configured to substantially break the force-locking and/or interlocking connection at least for the predetermined distance, and wherein the weighing unit is configured to establish the weight of the casting mold within the predetermined distance.

2. The conveying system according to claim 1, wherein the second speed is equal to or greater than the predetermined speed such that the weight of the casting mold is established without contact with the conveying unit.

3. The conveying system according to claim 1, wherein the conveying unit comprises at least a first belt unit and a second belt unit, on each of which at least one engagement element is arranged which is configured to engage with the casting mold in order to establish the force-locking and/or interlocking connection, wherein the first belt unit is substantially opposite and parallel to the second belt unit, wherein the conveying unit has a first guide element and a second guide element which are configured to guide the first belt unit and the second belt unit, wherein the first guide element and the second guide element are configured to increase the distance along a first axis between the engagement elements opposite one another.

4. The conveying system according to claim 3, wherein the first guide element and the second guide element are configured to increase the distance between the engagement elements up to a predetermined limit value in order to break the force-locking and/or interlocking connection for the predetermined distance.

5. The conveying system according to claim 3, wherein the first guide element and the second guide element are configured to reduce the distance between the engagement elements after leaving the predetermined distance in order to restore the force-locking and/or interlocking connection.

6. The conveying system according to claim 1, wherein the conveying unit is configured to place the casting mold onto the weighing unit within the predetermined distance in order to break the force-locking and/or interlocking connection.

7. The conveying system according to claim 6, wherein the conveying unit is configured to pick up the casting mold from the weighing unit past the predetermined distance.

8. The conveying system according to claim 3, wherein the first guide element and the second guide element are configured to displace the engagement elements along a second axis which is substantially orthogonal to the first axis in order to place the casting mold onto the weighing unit and/or pick it up from the weighing unit.

9. The conveying system according to claim 8, wherein the first guide element and the second guide element are configured to break and/or establish the force-locking and/or interlocking connection by means of a two-dimensional movement along the first axis and the second axis.

10. The conveying system according to claim 1, wherein the weighing unit has at least one moving element which is configured to transport the casting mold for the predetermined distance at the second speed.

11. The conveying system according to claim 1, wherein the conveying system has at least one sensor element, wherein the weighing unit is configured to establish the position of the casting mold by means of the sensor element, wherein the weighing unit is configured to establish the weight of the casting mold when the position of the casting mold is within the predetermined distance.

12. The conveying system according to claim 1, wherein the weighing unit comprises a lifting mechanism, wherein the lifting mechanism is configured to create a distance between the weighing unit and the conveying direction such that the weighing unit is devoid of contact with a casting mold for a predetermined period of time in order to tare the weighing unit.

13. A method for operating a conveying system for the production of food products, in particular confectionery, comprising the steps of:
positioning a casting mold on a weighing unit at a predetermined travel speed of the casting mold,
determining the weight of the casting mold by means of the weighing unit at at least the predetermined travel speed,
wherein the casting mold is substantially devoid of contact with a conveying unit of the conveying system when determining the weight of the casting mold.

14. A control unit for operating a conveying system, which, is configured to perform steps of the method according to claim 13, and/or is configured to be connected to a conveying system for transmitting signals, and/or is configured to receive a first speed signal and a second speed signal, wherein the first speed signal is indicative of a transport speed of a casting mold when it is in contact with a conveying unit, wherein the second speed signal is indicative of a conveying speed of a weighing unit when the casting mold is in contact with the weighing unit and is substantially devoid of contact with the conveying unit, wherein the control unit is configured to output a delta signal, wherein the delta signal is configured to adjust the first speed signal and/or the second speed signal to break the contact between the casting mold and the conveying unit, and/or to maintain the contact-free state.

15. The control unit according to claim 14, wherein the control unit is configured to receive a weight signal, wherein the weight signal is indicative of the mass of a food product with which the casting mold has been filled, wherein the control unit is configured to send an adjustment signal on the basis of the weight signal and a reference for the weight of the casting mold, wherein the adjustment signal is configured to bring the weight signal closer to the reference.

16. A control unit for operating a conveying system, which is configured to be connected to a conveying system according to claim 1 for transmitting signals, and/or is configured to receive a first speed signal and a second speed signal, wherein the first speed signal is indicative of a transport speed of a casting mold when it is in contact with a conveying unit, wherein the second speed signal is indicative of a conveying speed of a weighing unit when the casting mold is in contact with the weighing unit and is substantially devoid of contact with the conveying unit, wherein the control unit is configured to output a delta signal, wherein the delta signal is configured to adjust the first speed signal and/or the second speed signal to break the contact between the casting mold and the conveying unit, and/or to maintain the contact-free state.
